(19) United States
(12) Patent Application Publication
(10) Pub. No.: US 2010/0208939 A1
(43) Pub. Date: Aug. 19, 2010

(54) STATISTICAL OBJECT TRACKING IN COMPUTER VISION

(76) Inventor: Perttu Hämäläinen, Helsinki (FI)

Correspondence Address: Muncy, Geissler, Olds & Lowe, PLLC, 4000 Legato Road, Suite 310, FAIRFAX, VA, 22033, US

(21) Appl. No.: 12/664,837

(22) PCT Filed: Jun. 13, 2008
(86) PCT No.: PCT/FI08/50363

§ 371 Date: Apr. 9, 2010

(30) Foreign Application Priority Data
Jun. 15, 2007 (FI) 20075454

(51) Int. Cl. G06K 9/62

(52) U.S. Cl. 382/103

(57) ABSTRACT

A method and system for object tracking in computer vision. The tracked object is recognized from an image that has been acquired with the camera of the computer vision system. The image is processed by randomly generating samples in the search space and then computing fitness functions. Regions of high fitness attract more samples. Computations may be stored into a tree structure. The method provides efficient means for sampling from a very peaked probability density function that can be expressed as a product of factor functions.

### FIELD OF THE INVENTION

This invention is related to random number generating, optimization, and computer vision.

### BACKGROUND OF THE INVENTION

Computer vision has been used in several different application fields. Different applications require different approaches as the problem varies according to the applications. For example, in quality control a computer vision system uses digital imaging for obtaining an image to be analyzed. The analysis may be, for example, a color analysis for paint or the number of knot holes in plank wood.

One possible application of computer vision is model-based vision wherein a target, such as a face, needs to be detected in an image. It is possible to use special targets, such as a special suit for gaming, in order to facilitate easier recognition. However, in some applications it is necessary to recognize natural features from the face or other body parts. Similarly it is possible to recognize other objects based on the shape or form of the object to be recognized. Recognition data can be used for several purposes, for example, for determining the movement of an object or for identifying the object.

The problem in such model-based vision is that it is computationally very difficult. The observations can be in different positions. Furthermore, in the real world the observations may be rotated around any axis. Thus, a simple model and observation comparison is not suitable as the parameter space is too large for an exhaustive search.

Previously this problem has been solved by optimization and Bayesian estimation methods, such as genetic algorithms and particle filters. Drawbacks of the prior art are that the methods require too much computing power for many real-time applications and that finding the optimum model parameters is uncertain.

In order to facilitate the understanding of the present invention the mathematical and data processing principles behind the present invention are explained.

This document uses the following mathematical notation

x vector of real values

x^{T} vector x transposed

x⁽ⁿ⁾ the nth element of x

A matrix of real values

a^{(n, k)} element of A at row n and column k

[a,b,c] a vector with the elements a, b, c

f(x) fitness function

E[x] expectation (mean) of x

std[x] standard deviation (stdev) of x

|x| absolute value of x

In computer vision, an often encountered problem is that of finding the solution vector x with k elements that maximizes a fitness function f(x). The term fitness function is most often used in context of evolutionary optimization. In the context of Bayesian estimators, e.g., particle filters, the posterior probability density function is a analogous to a fitness function. Computing f(x) depends on the application of the invention. In model-based computer vision, x can contain the parameters of a model of a tracked object. Based on the parameters, f(x) can then be computed as the correspondence between the model and the perceived image, high values meaning a strong correspondence. For example, when tracking a planar textured object, fitness can be expressed as f(x)=e^{c(x)}−1, where c(x) denotes the normalized cross-correlation between the perceived image and the model texture translated and rotated according to x.

Estimating the optimal parameter vector x is typically implemented using Bayesian estimators (e.g., particle filters) or optimization methods (e.g., genetic optimization, simulated annealing). The methods produce samples (guesses) of x, compute f(x) for the samples and then try to refine the guesses based on the computed fitness function values. However, all the prior methods have the problem that they “act blind”, that is, they select some sampling distribution, e.g., a normal distribution centered at a previous sample with a high f(x), and then randomly generate a sample from the sampling distribution. The use of normal distributions is typical in evolution strategies optimization and Bayesian estimation where the posterior probability density is approximated as an additive Gaussian mixture.

There are many cases where it would be beneficial to be able to draw samples according to a probability density function that is formulated as a product of factor functions. For example, one can often define a prior probability distribution so that when sampling from the product of the prior and the sampling distribution, the samples focus on the most promising parts of the parameter space. For example, when tracking a face so that the parameterization is x=[x₀,y₀,scale] (each sample contains the two-dimensional coordinates and scale of the face), one may wish to only generate samples with such x₀,y₀ that the input image pixel at location x₀,y₀ is of face color. In this case, the prior may be an image obtained by processing the input image with a color difference filter. Traditionally, rejection sampling is used for generating the samples, that is, one rejects and regenerates samples that do not fall on face color areas. However, obtaining a suitable sample may require several rejected samples and thus an undesirably high amount of computing resources.

Sampling from a product may be desirable also if the fitness function f(x) is formulated as a product of factor functions so that it is very peaked, having a high value at the optimal x and a value close to zero for all non-optimal x. In this case, one may find the optimal x by treating f(x) as a probability density function and drawing samples accordingly. In theory, the optimal case is when f(x) is a Dirac delta function, so that only one sample needs to be drawn to find the optimal x. In practical computer vision, f(x) cannot be sampled directly, since it is not known beforehand but depends on each analyzed image. Many sampling methods exists that build an approximation of f(x) based on discrete samples of x and the corresponding fitness function values evaluated based on the input image. However, the methods perform poorly with Dirac or other very peaked probability densities. The main reason for this is that the previously generated samples do not provide proper gradient information of f(x) for efficiently focusing the search or sampling.

The present invention provides efficient means for generating samples according to a probability density formulated as the product of factor functions, provided that the definite integrals or means of the factor functions over portions of the parameter space can be evaluated. The actual probability density function does not have to be evaluated or integrated. The present invention can considerably increase the performance of model-based computer vision, such as widely used particle filter systems. The present invention works even when the product of the factor functions is very peaked.

### SUMMARY

The present invention discloses a method for tracking an object, wherein the object is represented by a model with a plurality of parameters and the possible parameter combinations constitute a search space. The method is initiated by determining an object to be tracked and acquiring an input image. The actual processing is initiated by selecting a portion of the search space. The selected portion is then mapped into new portions. For each new portion the product of the representative values of a plurality of factor functions within the portion is determined. Said selecting, splitting, and determining is repeated until a termination condition has been fulfilled.

In an embodiment of the invention the termination condition is the number of passes or a minimum size of a portion. In a further embodiment of the invention the mapping comprises splitting of the selected portion into new portions. In an embodiment of the invention the selection probability of a portion is proportional to the said product of the representative values of a plurality of factor functions within the portion. The representative value of a factor function within a portion may equal the mean value of the factor function within the portion. The representative values of at least one factor function may be determined using at least one integral image. In another embodiment of the invention one of the factor functions is the probability density function of a normal distribution. In a typical embodiment of the invention the portions are hypercubes represented by nodes of a kd-tree. Integral images are typically generated by processing the input image. Integral images are typically generated by using at least one of the following methods: processing the input image with an edge detection filter; comparing the acquired image to a model of the background; or subtracting consecutive input images to obtain a temporal difference image.

In an embodiment of the invention the method described above is implemented in a form of software. A further embodiment of the invention is a system comprising a computing device having said software. The system according to the invention typically includes a device for acquiring images, such as an ordinary digital camera being capable of acquiring single images and/or continuous video sequence.

The problem solved by the present invention is that of efficiently generating a random number or vector from a probability distribution, the probability density of which is expressed as a product of a plurality of functions, hereafter referred to as factor functions. The problem is frequently encountered, for example, in model-based computer vision. The invention allows one to generate the random number or vector without actually evaluating the product of factor functions, but instead computing means or integrals of the factor functions. In particular in computer vision, the means or integrals can be computed efficiently using pre-computed data, such as an integral image.

The present invention particularly improves the generation of samples in Bayesian estimation of model parameters so that the samples are likely to have strong evidence based on the input image. Previously, rejection sampling has been used for this purpose, but the present invention requires considerably less computing power.

The benefit of the present invention is that it requires considerably less resources than conventional methods. Thus, with same resources it is capable of producing better quality results or it can be used for providing the same quality with reduced resources. This is particularly beneficial in devices having low computing power, such as mobile devices.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a block diagram of an example embodiment of the present invention;

FIG. 2 is a flow chart of the method disclosed by the invention;

FIG. 3 shows an example of one-dimensional factor functions g(x), p(x) and the corresponding product g(x)p(x).

FIG. 4 illustrates the actual distribution of samples when sampling from the probability density g(x)p(x) in FIG. 3 using an embodiment of the invention;

FIG. 5 illustrates an example of model-based computer vision where the model is a circle and the fitness function is the product of image intensities at the model points. In the figure, the model points align with perceived edges.

FIG. 6 illustrates an example of the model points of FIG. 5 misaligning so that f(x) is zero;

FIG. 7 illustrates how portions of x₀,y₀ parameter space (coordinates of the circle center) map to portions within which the model points of the corresponding circles are located; and

FIG. 8 illustrates the mapping of FIG. 7 when the circle can vary in scale (denoted as the s-axis).

### DETAILED DESCRIPTION OF THE INVENTION

Reference will now be made in detail to the embodiments of the present invention, examples of which are illustrated in the accompanying drawings.

In the following, the example embodiments of the invention have two factor functions for the sake of simplicity, but an embodiment of the invention may have any number of factor functions.

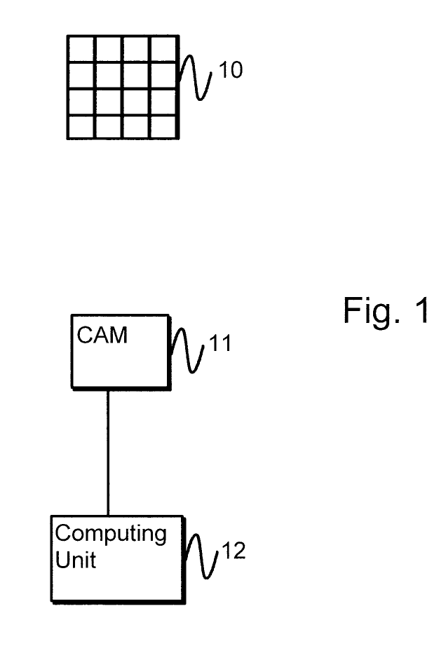

In FIG. 1, a block diagram of an example embodiment according to the present invention is disclosed. The example embodiment comprises a model or a target 10, an imaging tool 11 and a computing unit 12. The target 10 is in this application a checker board. However, the target may be any other desired target that is particularly made for the purpose or a natural target, such as a face. The imaging tool may be, for example, an ordinary digital camera that is capable of providing images at desired resolution and rate. The computing unit 12 may be, for example, an ordinary computer having enough computing power to provide the result at the desired quality. Furthermore, the computing device includes common means, such as a processor and memory, in order to execute a computer program or a computer implemented method according to the present invention. Furthermore, the computing device includes storage capacity for storing target references. The system according to FIG. 1 may be used in computer vision applications for detecting or tracking a particular object that may be chosen depending on the application. The dimensions of the object are chosen correspondingly.

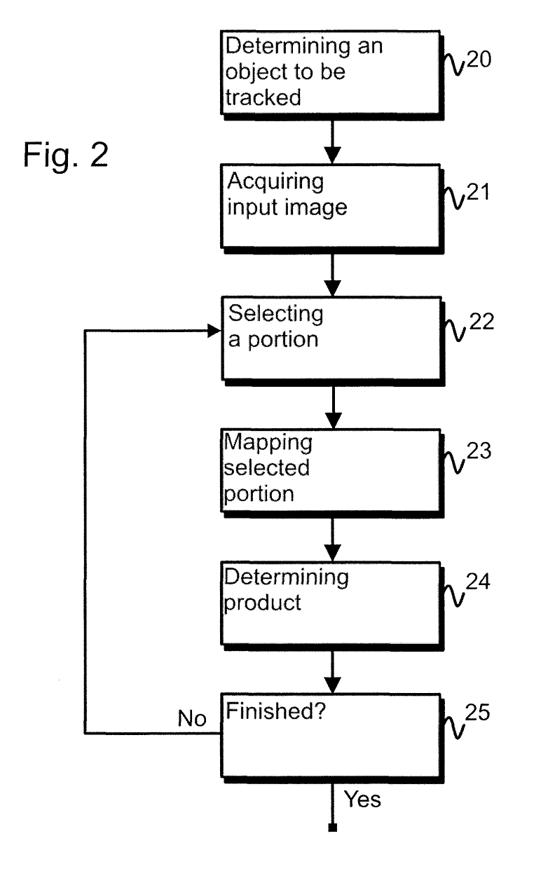

In FIG. 2 a method according to the invention is disclosed. The method is initiated by determining an object to be tracked, step 20. The object may be, for example, a target similar to the target 10 of FIG. 1. Then an image is acquired, step 21. Then a portion of the search space is selected, step 22. Then the selected portion of the search space is mapped into new portions, step 23. For each new portion the product of the mean values of a plurality of factor functions within the portion is determined, step 24. Then the termination condition is checked, step 25. Steps 22-24 including selecting, mapping, and determining are repeated until a termination condition has been fulfilled. The functionality of these steps is explained in more detail with references to pseudo-code examples.

In an embodiment of the invention, the k-dimensional search space is divided iteratively into portions and the integral or mean of f(x) over the portions is estimated. The optimal x is not necessarily found exactly, but at the end of the iteration, it is probable that the optimal x lies within a portion with high mean f(x). Depending on the application, x can be obtained, for example, by randomly selecting a point inside the portion with highest mean f(x).

The present invention is based on the idea of decomposing sampling from a real-valued multimodal distribution into iterated draws from binomial distributions. If f(x) is a probability density function, a sample from the corresponding distribution can be drawn according to the following pseudo-code:

```
Starting with an initial portion R of the space of
acceptable values for x, repeat{
  Divide R into portions A and B;
  Compute the mean values M_{A} and M_{B} of f(x) within the
  portions A and B;
  Assign A the probability M_{A}V_{A} / pₜₒₜ and B the probability
  M_{B}V_{B} / pₜₒₜ, where V_{A} and V_{B} are the volumes of the portions
  and pₜₒₜ= M_{A}V_{A} + M_{B}V_{B};
  Randomly set R=A or R=B according to the probabilities;
}
```

After iterating sufficiently, R becomes very small and the sample can then be drawn uniformly within R, or simply set equal to a point selected within R, e.g, its center. It should be noted that the step of randomly setting R=A or R=B according to the probabilities may be implemented, for example, by first generating a random number n in the range 0 . . . 1, and then setting R=A if n<M_{A}V_{A}/pₜₒₜ, and otherwise setting R=B.

The division of R into portions may be done, for example, by splitting R into two halves along a coordinate axis of the search space. The halves may be of equal size, or the splitting position may be deviated around a mean value in a random manner.

The present invention concerns particularly the case when f(x) is expressed as a product of factor functions, for example, f(x)=p(x)g(x). The pseudo-code above can be used to obtain samples, but computing the mean E[p(x)g(x)] within a portion can require too much computing power for a real-time implementation.

If p(x) or g(x) is constant, e.g., a uniform probability density function, E[p(x)g(x)]=E[p(x)]E[g(x)], that is, the mean of the product is equal to the product of the means of the factor functions. The present invention is based on the discovery that when inserted into the iteration of the pseudo-code, approximating E[p(x)g(x)] as E[p(x)]E[g(x)] produces good results even when the factor functions are not constant. This can lead to considerable computational savings.

As the iteration proceeds and the portions become smaller, the accuracy of the approximation increases so that errors made in the first iterations are partially corrected by the succeeding iterations. In an embodiment of the invention, sampling from f(x)=p(x)g(x) can be implemented according to the pseudo-code:

```
Starting with an initial portion R of the space of
acceptable values for x, repeat{
  Divide R into portions A and B;
  Compute the mean values M_{A} and M_{B} of g(x) within the
  portions A and B;
  Compute the mean values M_{A}′ and M_{B}′ of p(x) within the
  portions A and B;
  Assign A the probability M_{A}M_{A}′V_{A} / pₜₒₜ and B the
  probability M_{B}M_{B}′V_{B} / pₜₒₜ, where V_{A} and V_{B} are the volumes
  of the portions and pₜₒₜ= M_{A}M_{A}′ V_{A} + M_{B}M_{B}′V_{B};
  Randomly set R=A or R=B according to the probabilities;
}
```

The former pseudo-code can be considered as a special case of the latter pseudo-code where p(x) is constant so that the terms M_{A}′ and M_{B}′ can be removed.

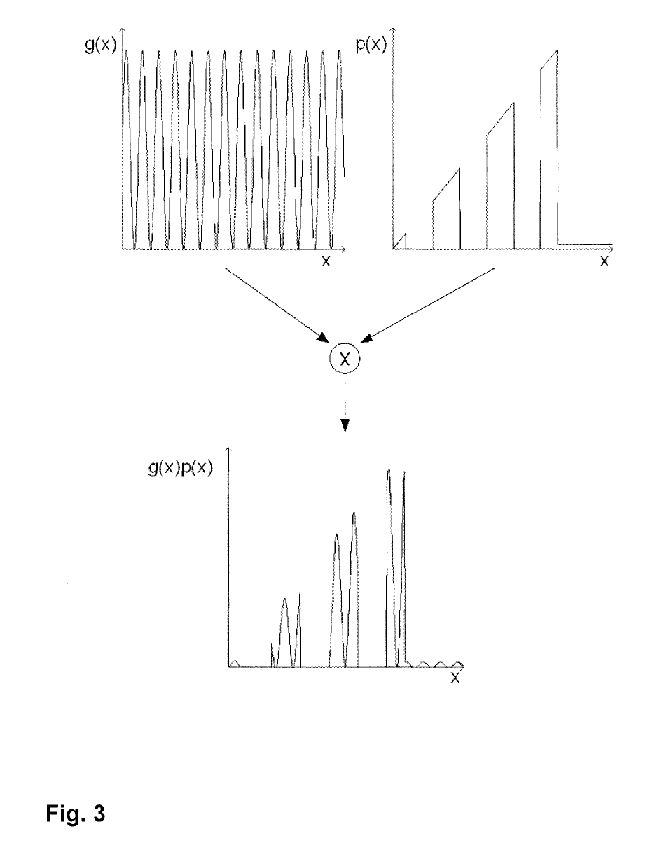

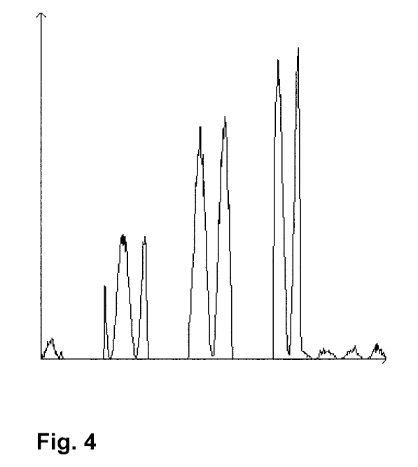

FIG. 3 shows an example of one-dimensional g(x), p(x) and the corresponding product g(x)p(x). FIG. 4 shows the actual distribution of samples when sampling from the probability density g(x)p(x) according to the pseudo-code so that R is halved to produce A and B. The surprising results are that the distribution of samples closely resembles the exact g(x)p(x) in FIG. 3. Good results can be obtained for a wide variety of factor functions.

There are several applications for the present invention. For example, in computer vision object tracking, g(x) may be considered an evidence function that can be evaluated based on comparing the input image to the model of the tracked object with the parameters x, and p(x) may be considered a prior probability density function for x, obtained from the tracking results of previous frames by assuming continuous motion.

The present invention can also be applied to boost the performance of existing Bayesian estimators or stochastic optimization methods. Many such methods, such as Simulated Annealing (SA), contain a step where a new sample is drawn from a sampling distribution with statistics computed from previous samples. For example, the sampling distribution may be a normal distribution centered at the previous sample. If p(x) denotes the probability density of the sampling distribution and g(x) denotes an evidence function, the present invention may be used to generate samples optimally so that they follow p(x)g(x), that is, the samples focus on areas where both the sampling probability p(x) and evidence g(x) are high. Traditionally, rejection sampling is used to only accept samples with enough evidence, but compared to the present invention, rejection sampling is much heavier computationally.

Furthermore, the present invention may be applied when computing the mean of f(x) within a portion can be decomposed into computing the sum of image pixels over an area or areas. The computation can be efficiently implemented using a computer vision technique called integral images. Typically, the integral images have to be computed only once for each analyzed image, after which several samples can be created with minimal computational cost.

An integral image is computed from some image of interest. The definite integral (sum) of the pixels of the image of interest over a rectangle can then be computed as a linear combination of the pixels of the integral image at the rectangle corners. This way, only four pixel accesses are needed for a rectangle of an arbitrary size. Integral images may be generated, for example, using many common computer vision toolkits, such as the OpenCV (Open Computer Vision library). If i(x,y) denotes the pixel intensity of an image of interest, and iᵢ(xᵢ,yᵢ) denotes the pixel intensity of an integral image, one example of computing the integral image is setting iᵢ(xᵢ,yᵢ) equal to the sum of the pixel intensities i(x,y) within the region x<xᵢ, y<yᵢ. Now, the definite integral (sum) of i(x,y) over the region x₁≦x<x₂, y₁≦y<y₂ can be computed as iᵢ(x₂,y₂)−iᵢ(x₁,y₂)−iᵢ(x₂,y₁)+iᵢ(xₗ,y₁).

One may also compute a tilted integral image for evaluating the integrals of rotated rectangles by setting iᵢ(xᵢ,yᵢ) equal to the sum of the pixel intensities i(x,y) within the region |x−xᵢ|<y, y<yᵢ.

The present invention provides means for combining top-down model-based computer vision with low-level image information stored in pixel importance images. A pixel importance image (PII) is an image where the intensity of a pixel is proportional to its probability of belonging to a feature or object of interest. For example, when tracking a face, it may help to focus the search on areas of the input image that are the color of skin. A PII may then be computed based on the skin color prior. In the most simple case, the scale of the face is known so that one only needs to sample x=[x₀,y₀], where x₀,y₀ are the coordinates of the face. If g(x) denotes the intensity of the pixel importance image at x and p(x) is a sampling distribution obtained from a parameter estimator, the present invention may be utilized to generate optimal samples with minimal computing resources. Provided that R is a rectangle that is split into halves A and B, the mean of g(x) within A or B can be efficiently computed using an integral image computed from the PII. The mean of the sampling distribution, for example, a normal distribution, can also be efficiently approximated using pre-computed values stored in a computer memory.

Even if the parameterization is more complex, the present invention may be used to obtain sample values for some of the parameters. For example, when tracking a face, the parameterization can be x=[x₀,y₀,s], where s denotes scale and x₀,y₀ denote the coordinates of the face in the input image. For each sample vector, if x₀,y₀ are regarded independent from s (e.g., the covariance matrix of the sampling distribution is diagonal), they can be sampled according to the present invention, and scale s can be sampled simply from the sampling distribution. In general, when there are image coordinate pairs in the parameterization, they can be mapped directly into areas and sampled independently of the other parameters. For example, if the portion R is the 3-dimensional hypercube for which xₘᵢₙ<x₀<xₘᵢₙ, yₘᵢₙ<y₀<xₘᵢₙ, sₘᵢₙ<s<sₘₐₓ, the hypercube can simply be mapped into the rectangle for which xₘᵢₙ<x₀<xₘᵢₙ, yₘᵢₙ<y₀<xₘᵢₙ.

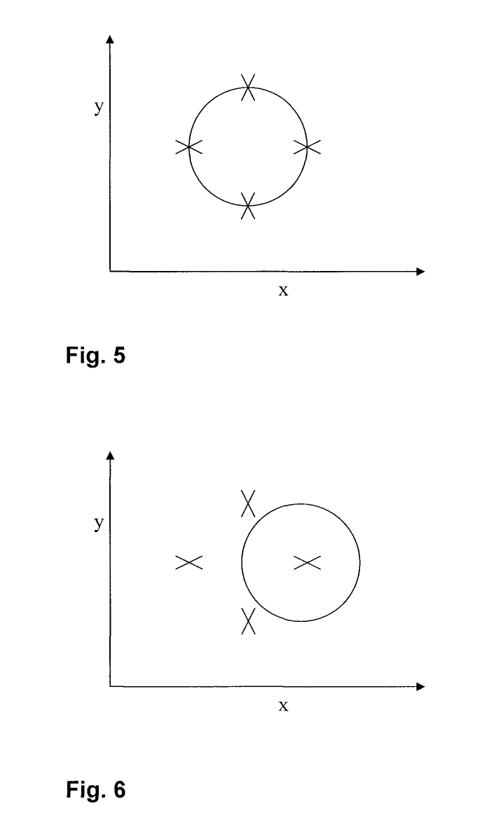

In a general case, the fitness function f(x) may be expressed as the product of several factor functions that measure the evidence of x, such as the product of PII values at a plurality of model points. Consider a case where a circle is to be found in an image. The sampled parameters are the coordinates x₀,y₀ of the circle center. The model defines the circle as four points and f(x) is computed using a pixel importance image obtained using an edge detector, such as a Canny detector. f(x) equals the product of PII pixel intensities at the model points translated according to the model parameters. This way, the fitness is nonzero only if the parameters are correct, provided that the background does not contain significant edges. FIG. 5 shows an example of the model points aligning with the perceived edges, thus yielding a nonzero fitness. FIG. 6 shows an example of the model points misaligning so that f(x) is zero.

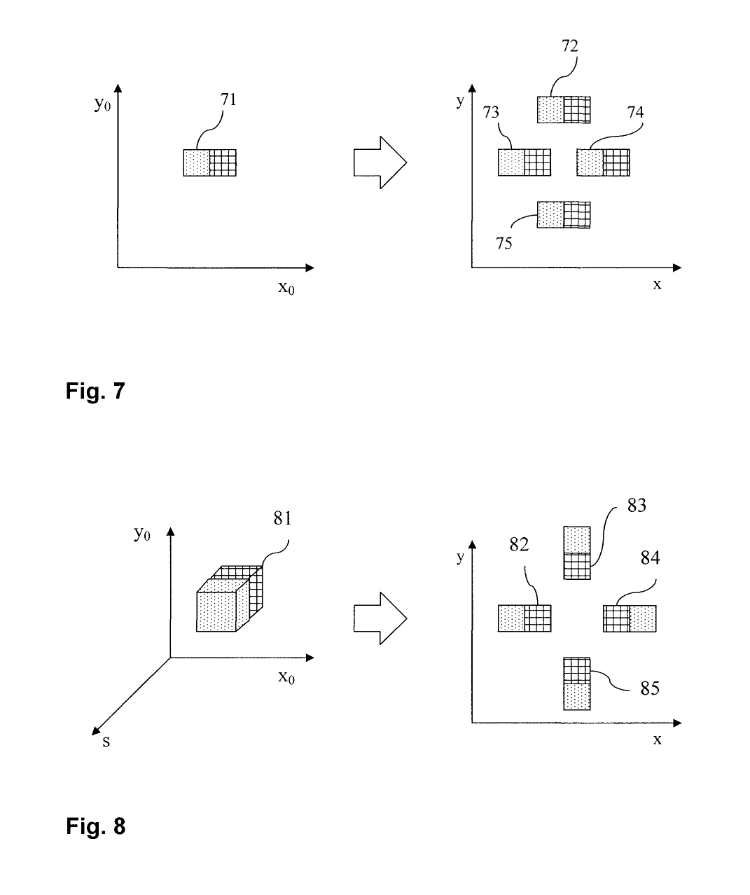

FIG. 7 shows how two portions of x₀,y₀ coordinate space map to areas of the four circle model points in the PII. In this case, if x₀,y₀ vary within the rectangle 71 in the parameter space, the locations of the model points vary within rectangles 72, 73, 74, 75 in the PII. According to the present invention, the mean of f(x) within a rectangle in x₀,y₀ space can thus be computed as the product of the means of the PII within the corresponding model point rectangles.

FIG. 8 shows the mapping of FIG. 7 when the circle can vary in scale so that the parameterization becomes x=[x₀,y₀,s]. In this case, if x₀,y₀,s vary within the cube 81 in the parameter space, the locations of the model points vary within rectangles 82, 83, 84, 85 in the PII. According to the present invention, the mean of f(x) within a cube may be computed as the product of the means of the PII within the corresponding model point rectangles. The means can be efficiently evaluated using an integral image computed from the PII.

If f(x) is not peaked enough or the estimate of the means is not precise, several samples may be needed to obtain a solution vector x sufficiently close to the true optimum. In this case, it is not efficient to start the sampling procedure all over again for each new sample. Instead of always selecting one of the two newly created portions, one can select a portion globally from all the previous portions. This way, the pseudo-code for the most general case becomes:

```
Repeat until a termination condition is satisfied{
  Select a portion of the search space so that the selection
  probability of a portion is proportional to the mean of
  f(x) over the portion multiplied with the volume of the
  portion;
  Split the selected portion into new portions;
  Compute the mean of f(x) within the new portions as the
  product of the means of the factor functions of f(x). The
  means of the factor functions can be computed either
  directly or through mapping the portions to lower-
  dimensional portions, such as areas in pixel importance
  images;
}
```

The splitting of the search space into portions provides a piecewise constant approximation of f(x). The approximation gets more precise as more samples are generated.

If the search space portions are hyper-cubes (rectangles in case of two dimensions, cubes in case of three dimensions), the selection and splitting can be efficiently implemented using a tree-like data structure, such as a kd-tree, where each tree node has two children. When a portion (kd-tree leaf) is selected and split, two new leaf nodes are generated. The selection probabilities can be propagated towards the root of the tree by setting the probability of a parent node equal to the sum of the probabilities of its children. This way, the leaf to split can be found by first selecting the root node and then always selecting a child of the previously selected node based on the probabilities of the children, until arriving at a leaf node.

The pseudo-code uses the expression “lower-dimensional portions” instead of simply pixel importance images because in some cases, it may be useful to use three-dimensional or higher-dimensional data structures analogous to integral images, which are then used in the manner explained above.

Although the discussion above refers to computing the mean of a factor function within a portion of the parameter space, an embodiment of the invention may also use other similar statistical measures, such as the median value. In the claims, the term representative value is used as a common term for mean, median or other suitable measures.

Although this document mainly concerns the field of computer vision, the parameter solving method disclosed may be applicable to other fields, such as artificial intelligence or procedural animation. In artificial intelligence, an embodiment of the present invention may be used for problem solving so that x denotes a solution to a problem, and f(x) denotes the predicted fitness of the solution. In procedural animation, an embodiment of the present invention may be used for controlling the motion of an animated character so that x denotes the control parameters, and f(x) is a prediction of how successful the controlled motion is in reaching a goal, such as jumping as high as possible.

It is obvious to a person skilled in the art that with the advancement of technology, the basic idea of the invention may be implemented in various ways. The invention and its embodiments are thus not limited to the examples described above; instead they may vary within the scope of the claims.

1-11. (canceled)

12. A method for tracking an object, wherein the object is represented by a model with a plurality of parameters and the possible parameter combinations constitute a search space, the method comprising:
determining an object to be tracked;
acquiring an input image;
characterized in that the method further comprises:
selecting a portion of the search space;
mapping the selected portion of the search space into new portions;
for each new portion determining a representative value for each factor function within the portion and determining the product of the said representative values;
repeating said selecting, mapping and determining, until a termination condition has been fulfilled, wherein the selection probability of a portion is based on said product corresponding to the portion.

13. The method according to claim 12, characterized in that the termination condition is the number of passes or a minimum size of a portion.

14. The method to claim 12, characterized in that the mapping comprises splitting of the selected portion into new portions.

15. The method according to claim 12, characterized in that the selection is restricted to the new portions of the previous mapping step.

16. The method according to claim 12, characterized in that the representative value of a factor function within a portion equals the mean value of the factor function within the portion.

17. The method according to claim 12, characterized in that the representative values of at least one factor function are determined using at least one integral image.

18. The method according to claim 12, characterized in that one of the factor functions is the probability density function of a normal distribution.

19. The method according to claim 12, characterized in that the portions are hypercubes represented by nodes of a kd-tree.

20. The method according to claim 12, characterized in that generating the integral images by processing the input image.

21. The method according to claim 20, characterized in that generating at least one integral image by using at least one of the following methods:
processing the input image with an edge detection filter;
comparing the acquired image to a model of the background; or
subtracting consecutive input images to obtain a temporal difference image.

22. A computer program for tracking an object embodied in a computer readable medium, wherein the object is represented by a model with a plurality of parameters and the possible parameter combinations constitute a search space, wherein the computer program is embodied on a computer-readable medium comprising program code means adapted to perform the method according to claim 1 when the program is executed in a computing device.

23. A system for tracking an object, wherein the object is represented by a model with a plurality of parameters and the possible parameter combinations constitute a search space, which system comprises:
an object to be tracked;
a camera; and
a computing unit, wherein the system is configured to determine an object to be tracked and acquire an image;
characterized in that the system is further configured to perform the steps of determining an object to be tracked, acquiring an input image, selecting a portion of the search space, mapping the selected portion of the search space into new portions, for each new portion determining a representative value for each factor function within the portion and determining the product of the said representative values, and repeating said selecting, mapping and determining, until a termination condition has been fulfilled, wherein the selection probability of a portion is based on said product corresponding to the portion.

24. The system according to claim 23, wherein the system is arranged to perform said steps by executing a computer program for tracking an object embodied in a computer readable medium, wherein the object is represented by a model with a plurality of parameters and the possible parameter combinations constitute a search space, wherein the computer program is embodied on a computer-readable medium comprising program code means adapted to perform the method according to claim 1 when the program is executed in a computing device.
